(19) United States
(12) Patent Application Publication
(10) Pub. No.: US 2009/0158252 A1
(43) Pub. Date: Jun. 18, 2009

(54) Method for Creating an Approximation Graph Relating to the Behavior of the Man-Machine Interface of an Application

(75) Inventors: Pierre Cregut, Saint Quay-Perros (FR); Cuihtlauac Alvarado, Lannion (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 12/085,870

(22) PCT Filed: Nov. 29, 2006
(86) PCT No.: PCT/FR2006/051249

§ 371 Date: May 29, 2008

(51) Int. Cl. G06F 9/44

(52) U.S. Cl. 717/116

(57) ABSTRACT

An approximation graph for behaviors of the man/machine interface of an application that is obtained automatically by this method can be defined as follows: the nodes (N1, N2, N3) of the graph represent sets of screen objects encoding screens for display during execution of the application and characterized by a property in common. A screen object can be represented by one node only; the oriented arcs (α) of the graph connecting an origin node (N1) to a destination node (N3) illustrate the possibility of transiting, as the result of an event occurring, from a screen described by an object of an origin to a screen described by an object of a destination.

### BACKGROUND OF THE INVENTION

The present invention relates to a method of creating an approximation graph for the behaviors of the man/machine interface of an application.

It also relates to a computer implementing the method.

In preferred manner, the method of the invention makes it possible, starting from a compiled J2ME/MIDP application (a Java application for mobile telephony), to extract an approximation graph for the behaviors of the interface presented by said application, i.e. an automaton having states that approximate to the different screens that the application presents during execution, and transitions that are events for passing from one screen to another. The graph is a finite approximation of the ideal graph for all of the behaviors of the application, which ideal graph is infinite. The invention thus finds a preferred utilization by teams for validating downloadable applications.

The developers of such applications generally transmit them in the form of closed code without any specifications about their operation.

The purpose of the method is to provide such evaluators with the beginning of a specification, which specification is extracted directly from the compiled code. It makes it possible in particular to discover the set of screens that are available and the transitions that can be activated.

The graph can be used as a basis by other tools that will enrich it by performing other analyses.

The technical field of the invention is that of automatically analyzing programs, and more particularly man/machine interfaces, where such programs are written in object-oriented languages with typed bytecode (where a “bytecode” is a compiled code, as described below).

It is recalled that a typed language is a language that makes it possible, prior to execution, to verify that all of the data that is handled complies with rules of proper formation, such that said execution cannot become uncontrolled.

The invention applies to evaluating applications written in the Java programming language that makes use of the MIDP libraries.

The invention also applies to other typed bytecodes (in particular .net), and to other graphical environments relying on describing the man/machine interface by graphical objects and event mangers (e.g. Java AWT).

The invention applies mainly to testing applications for which executable code is not available.

It can also apply to testing applications for which source code is available, but no specification.

Firstly, it is recalled that the Java language is an object-oriented language. A Java program is constituted by a set of “class” definitions. Each class can be instanced on execution of “objects”, which are dynamic structures containing “fields” that are local variables specific to the object, and “methods” that are procedures specific to the class.

A new object is created by a special instruction of the language that takes as a parameter the name of the class that serves as the model.

On being compiled, a Java program generates a pseudo-machine language known as “Java bytecode”, which code is actually executable by an execution environment known as a “virtual machine”.

Like the source language, Java bytecode is a typed language.

Verification of the bytecode by the virtual machine, prior to executing the code, constitutes the basis for safety mechanisms. This relies on invariants of form: such a piece of code cannot be executed unless some other piece of code has been executed beforehand.

It is also recalled that the MIDP profile is a set of libraries specialized for using the J2ME platform on portable telephones. For further information, the person skilled in the art can refer to the specification (Java Specification Request) entitled “Mobile information device profile (MIDP)”, Version 2.0, Java Community Process, November 2002.

MIDP provides in particular the interfaces with the terminal: managing network connections, the man/machine interface, and access to a persistent data space. MIDP relies on the J2ME/CLDC version of the Java language as defined in the specification (Java Specification Request) entitled “Connected limited device configuration (CLDC)”, Version 1.1, Java Community Process, 2002. This is a light version of the language, in which, in particular:
it is not possible to load new libraries dynamically: the application is defined in full by the code that is loaded; and
there is no access to reflexivity APIs (where API serves to manipulate application code and content directly in the java.lang.reflect package) on the code that could enable method calls to be built dynamically.

In known manner, the content of a screen in an MIDP application is defined by the content of a “screen” object of the javax.microedition.Icdui.Screen class in MIDP.

This content can be specialized by storing other objects (e.g. items in a form) with the help of methods that are specific to this object. The following can be identified amongst these objects:
“commands” that define software buttons displayed on the screen. The user can select them by pressing real buttons on the keypad. Pressing a software button triggers an event; and
“management objects” or “event listener objects” that contain respective methods called on each event.

The term “event” should be understood as any action performed by the user or the environment that triggers execution of code in the application, e.g. the user pressing a button, or a time delay expiring.

When the user selects one of these software buttons displayed on the screen, the listener method of the current screen is called, with the following parameters: the object describing the current screen; and the object describing the software button.

Normally, the method contains both the code for computing the action to be carried out and a method call for putting the following screen into place.

For the purpose of analyzing source code, so-called “reverse engineering” methods are known that start from the source code of an application in order to reconstruct elements of a specification so as to enable the code to be “re-engineered”.

An example is the Lexient tool collection available on the Internet at the following address http://www.lexientcorp.com/, 2004 that enables C, C++, and Java program information to be extracted.

In that method, the unit being handled is the piece of code and there is no notion of an instance or an attached instance class. The tool thus makes it possible to see where the various pieces code are used, but does not make it possible to recreate a dynamic structure.

Other methods, e.g. as described in the article by N. Mansurov and R. Probert entitled “Dynamic scenario-based approach to re-engineering of legacy telecommunication software”, in R. Dssouli, G. V. Bochmann, and Y. Yahav, publishers, 9th SDL Forum, Montreal, June 1999, Elsevier Science Publishers V.B. (North-Holland) rely on developing tools that extract automatons representing a specification for a system from a set of execution traces.

Such tools require traces, and therefore require tests to be performed. They cannot be used before undertaking a campaign of tests.

The invention serves to solve the above problems.

### OBJECT AND SUMMARY OF THE INVENTION

To this end, in a first aspect, the invention provides a method of creating an approximation graph for the behaviors of the man/machine interface of an application, said application being written in an object-oriented language with classes and with typed bytecode executing in an execution environment of a terminal provided with a display device, said application handling screen objects representing the content at a given instant of the display device, each screen object being associated by an association method with an event manager object including a callback method defined for the class of said event manager object and called directly by the execution environment.

This method comprises:
a step of defining at least one screen representative for each application instruction in which a screen object is instanced;
a step of defining at least one manager representative for each application instruction in which an event manager object is instanced;
a first stage of identifying, for each screen representative, the manager representatives that were defined for instantiating an event manager object associated with a screen object for the instantiation of which said screen representative was defined;
a second stage of identifying, for each group of manager representatives that were defined for instantiating event manager objects including the same callback method, the screen representatives that were defined for the screen objects that are put into place during execution of said callback method; and
a step of creating a graph comprising both nodes, each illustrating a screen representative, and arcs, each connecting an “origin” node to a “destination” node if, and only if, there exists a screen representative such that:
   this screen representative was identified during said first stage for the screen representative illustrated by said “origin” node; and
   the screen representative illustrated by the “destination” node was identified during said second stage for the manager representative.

Consequently, the method of the invention for creating a graph makes it possible with a succession of steps that are completely automatic to obtain an approximation of the behavior graph that includes all of the transitions for going from one screen to another (such an approximation is said to be “conservative”).

This result is particularly advantageous, since presently-known manual methods, in which developers work by successive approximations starting from an entry point and working through the code in one way or another, do not guarantee that the graph is exhaustive, where such exhaustivity is very difficult to obtain in practice with an application that is complex.

In a particular implementation, the object-oriented language with classes may be the Java language, the operating environment may be the MIDP environment, and the terminal may be a portable telephone.

The invention can also be applied to portable telephone applications in Windows ME complying with the .NET standard available from the supplier Microsoft.

The approximation graph for the behavior can be defined as follows:
the nodes of the graph represent sets of screen objects encoding screens for display during execution of the application and characterized by a property in common. A screen object can be represented by only one node; and
the oriented arcs of the graph connecting an origin node to a destination node illustrate the possibility of making a transition from a screen described by an origin object to a screen described by a destination object as a result of an event occurring.

In the prior art, the only approximations to the behavior graph that are known have been built “by hand”, while testing execution of the application and observing the actions executed during each test.

The invention thus serves advantageously to automate the creation of an approximation of the ideal graph, and to do so without executing the application.

The invention also makes it possible to provide a behavior graph illustrating the functioning of an application exhaustively, whereas in the methods known in the state of the prior art there is always a risk that some of the functions of the application will not be tested.

Preferably, in order to implement the first stage, the instructions of the application in which a call is made to the association method are determined, and for each call to said method, the following are determined:
the screen representatives that were defined for instantiating screen objects that can be passed as arguments in said call; and
the manager representatives that were defined for instantiating event manager objects that can be passed as arguments in said call.

In a preferred implementation of the invention, during the second stage, the following are determined beforehand for each callback method:
the instructions of the application in which there is instantiated an event manager object that includes said callback method;
the manager representatives that were defined for instantiating these event manager objects;
the calls to the screen change method that might occur during execution of said callback method; and
the screen representatives that were defined for instantiating screen objects that can be passed as arguments in each of the calls to the screen change method.

Preferably, a prior step is performed of determining, for each manager representative, the declared variables in the application that might contain an event manager object for the instantiation of which the manager representative was defined.

The above operation is known as “points-to analysis”. For the Java language, this operation can be performed directly on bytecode. The result of this analysis can be represented by a “points-to analysis graph” connecting each of the code points where objects are created to the code points where those objects are used. It should be observed that the points-to analysis graph and the graph approximating the behavior of the application correspond to two concepts that are quite distinct: more precisely, information is extracted from the first in order to build the second.

In preferred manner, and similarly, a prior step is performed of determining, for each screen representative, the declared variables in the application that might contain a screen object for the instantiation of which the screen representative was defined.

In a preferred implementation, the various steps of the method are determined by computer program instructions.

Consequently, the invention also provides a computer program on an information medium, the program including instructions adapted to implement the above-mentioned method of creating a graph.

The program can make use of any programming language, and can be in the form of source code, object code, or code intermediate between source code and object code, such as in a partially compiled form, or in any other desirable form.

The invention also provides a computer-readable information medium, including instructions of a computer program as mentioned above.

The information medium may be any entity or device capable of storing the program. For example the medium may comprise storage means such as a read-only memory (ROM), e.g. a CD ROM, or a microelectronic circuit ROM, or it may be magnetic recording means, e.g. a floppy disk or a hard disk.

Furthermore, the information medium may be a transmissible medium such as an electrical or an optical signal, suitable for being conveyed via an electrical or optical cable, by radio, or by other means. The program of the invention may in particular be downloaded on a network of the Internet type.

Alternatively, the information medium may be an integrated circuit in which the program is incorporated, the circuit being adapted to execute or be used in the execution of the method in question.

The invention also provides a computer including the storage medium briefly mentioned above.

### BRIEF DESCRIPTION OF THE DRAWINGS

Other characteristics and advantages of the present invention appear from the following description with reference to the appendix and the drawings that show an implementation having no limiting character, and in which:
Appendix 1 shows an example of computer program source code for coding the behavior of the man/machine interface of an application;

FIGS. 1 to 3 are flow charts showing the main steps in the method of creating a graph in accordance with the invention in a particular implementation;

FIG. 4 represents a computer 10 in accordance with the invention; and

FIG. 5 shows the behavior approximation graph corresponding to the source code given by way of example in Appendix 1.

### DETAILED DESCRIPTION OF AN IMPLEMENTATION

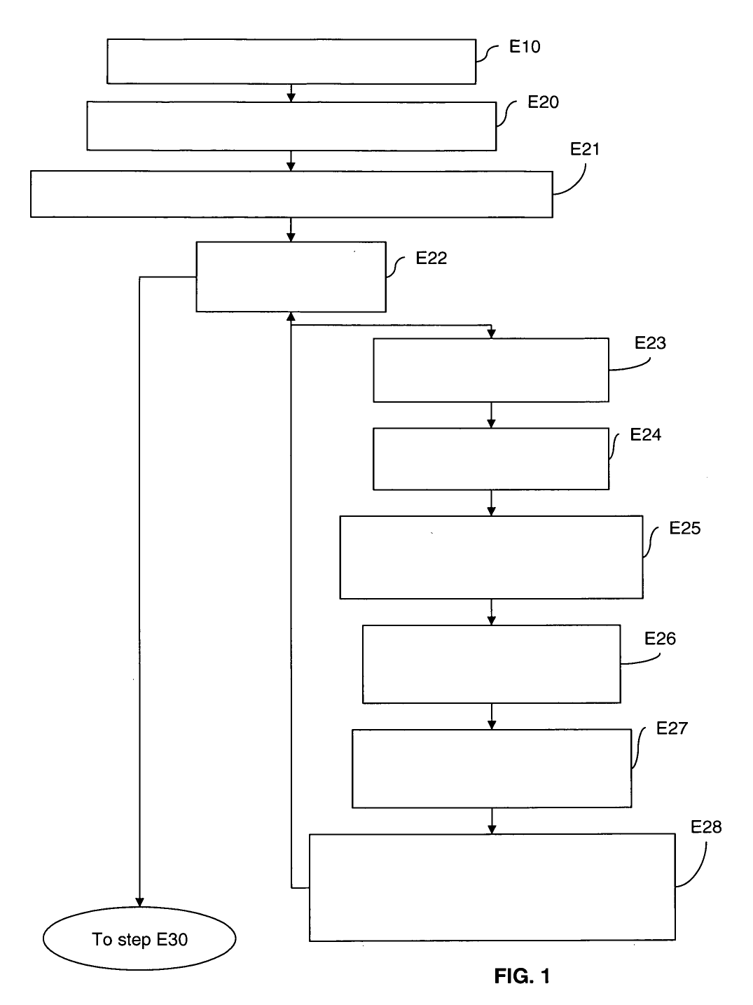

FIGS. 1 to 3 are flow charts showing the main steps of a method in accordance with the invention for creating an approximation graph for behavior in a particular implementation of the invention.

In the example described, the behavior approximation graph is constructed for the source code given in Appendix 1.

In known manner, a “suite” of “midlets” is constituted by a set of classes that are compiled and stored together in an archive file.

A “midlet” is an entry point into the set. In this example, references in parentheses, e.g. (I1), identify points in the code. They are placed immediately after the instruction they label (in general a method call or a comparison).

Initially (instructions I1, I2, I3), variables screen1, screen2, and screen3 are declared that are screen contents of the Form type and that are to contain information for display.

Thereafter (instructions I4, I5, I6), three commands are declared that represent buttons for going from one screen to another in the display. Each command is characterized by the text that is displayed on the button.

Thereafter, a “display” variable is declared that contains a pointer to the object representing the screen. It is the content of this object that is modified to change the display.

The method Test2 is the builder of the class Test2. It is called on launching the midlet in order to create an instance.

The “display” variable is updated and the respective messages are added to each of the screens, wrapping them in an object that inherits the Item class specialized in displaying strings of characters (StringItem).

Thereafter, the various buttons are stored in screens.

Thus, the person skilled in the art will understand from instructions I7, I8, and I9 that the “ok” button is available in the three screens: screen1, screen2, and screen3.

Thereafter, in instructions I13 and I14, event manager objects (CmdListener1 and CmdListener2) are created and one of these event manager objects is associated with each of the forms.

Each time the user presses a button, the event manager object associated with the corresponding form is called.

The screen objects are associated with the event manger objects in instructions I15 to I17, using an association method: setCommandListener.

The following three functions startApp, pauseApp, and destroyApp define the actions performed during transitions between the various states of the life cycle of a midlet, the midlet being controlled by a manager within the terminal (e.g. a telephone).

The function startApp puts a first visible form into place, specifically the screen screen1 (instruction I18).

Thereafter, the classes defining the event managers are defined. These classes implement the CommandListener interface, which means that they contain a commandAction method complying with the type specified below, i.e. taking as an argument a command and a screen content (e.g. a form), and not returning any information. These methods are called when a key is pressed.

The first argument is then the name of the virtual button that has been activated and the second argument is the content of the screen that was being displayed.

The chosen behavior is selected by using these two items of information.

Thus, if the button is “exit”, the midlet is stopped by a standard stop procedure (instructions I19 and I26).

If the button is “help” (instructions I20 and I27), help is displayed (instructions I21 and I28).

Finally, if the button is “ok”:
in the first manager object (instruction I22), the screen screen1 is displayed (instruction I24), or the screen screen2 is displayed (instruction I25) depending on the starting screen (instruction I23); and
in the second manager object (instruction I29), the screen screen1 is always displayed.

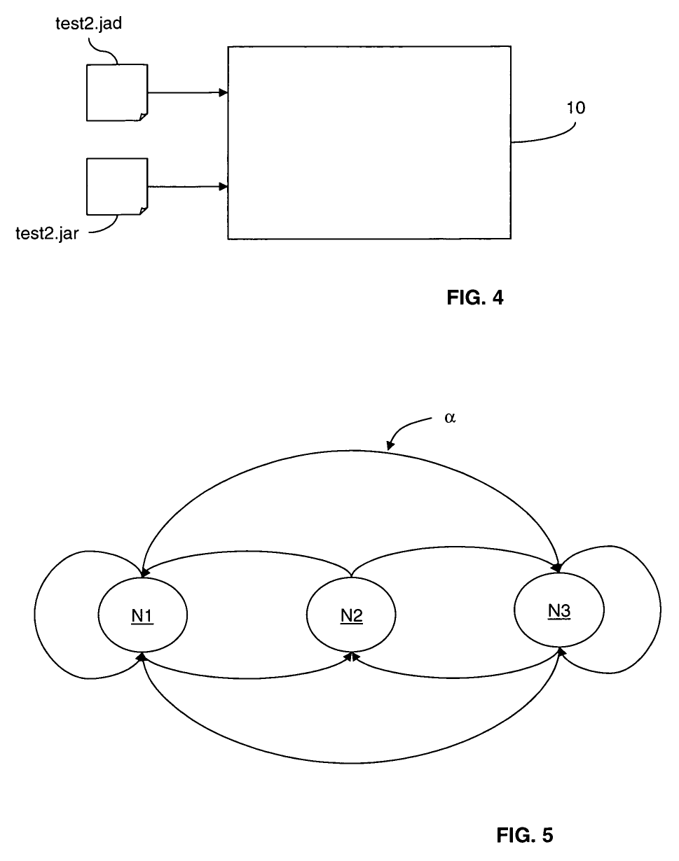

FIG. 4 represents a computer (or evaluator) in accordance with the invention. It comprises a storage medium (a memory) having stored thereon a computer program comprising instructions for implementing the graph method of the invention, having as its main steps those described with reference to FIGS. 1 to 3 in this preferred implementation.

The evaluator 10 does not receive the source code of Appendix 1, but it receives a compiled version made up of two files:
a text file (test2.jad) describing the midlet, this file also being known as a JAD file (for Java Descriptor); and
a file containing the compiled code of the midlet. This is a Java archive containing the code for each of the classes. In the example described herein, it is called test2.jar.

There follows a description of the main steps of the creation method of the method of the invention for building the approximation graph for the behavior of the application man/machine interface having the source code given in Appendix 1.

This application is written in an object-oriented language with classes that executes in the execution environment of a terminal provided with a display device, e.g. a mobile telephone.

As described above, this application handles three screen objects: screen1; screen2; and screen3 that represent the content at a given instant of the display device.

Each screen object is associated by the setCommandListener association method with an event manager object CmdListener1 or CmdListener2.

Each of these event manager objects CmdListener1 and CmdListener2 comprises a callback method CmdListener1.commandAction and CmdListener2.commandAction, these methods being defined for the event manager object class.

These callback methods are called directly by the execution environment, i.e. MIDP in the implementation described herein.

During a first step E10, a screen representative is defined for each instruction of the application in which a screen object is instanced.

Thus, three screen representatives are defined, respectively I1, I2, and I3, corresponding to the instructions of the application in which the screen objects screen1, screen2, and screen3 are instanced respectively.

This step E10 is followed by a step E20 of defining a manager representative for each instruction of the application in which an event manager object is instanced.

In the example described herein, these manager representatives are respectively I13 and I14 corresponding to the instructions I13 and I14 for instantiating the event manager object CmdListener1 and CmdListener2.

This step E20 is followed by a step E21 of determining, by points-to analysis, all of the instructions of the application that call the association method.

In the example described herein, these instructions are the instructions I15, I16, and I17 calling on the association method setCommandListener.

This step E21 is followed by a loop constituted by steps E22 to E28, the loop being followed for each of the instructions I15, I16, and I17 identified in the preceding step E21.

More precisely, this loop comprises a first step E23 of determining, for each screen representative I1, I2, I3, all of the declared variables in the application that might contain a screen object screen1, screen2, or screen3 for which the instantiation of this screen representative has been defined.

The person skilled in the art will understand that these variables, which are implicit in the source code of Appendix 1, are advantageously made explicit in the precompiled bytecode.

This step E23 is followed by a step E24 of searching for the screen objects contained in these variables.

In the example described herein, the screen object arguments are respectively screen1, screen2, and screen3 for the instructions I15, I16, and I17 calling on the setCommandListener association method.

This step E24 is followed by a step E25 of identifying the screen representatives defined for the instantiation of the screen objects identified in the preceding step E24.

These screen representatives are respectively I1, I2, and I3 for the screen object arguments screen1, screen2, and screen3.

This step E25 is followed by a step E26 of identifying the declared variables in the application that might contain an event manager object, these variables being explicit in the bytecode.

This step E26 is followed by a step E27 of identifying the event manager objects contained in these variables.

In the example described herein, these event manger objects are respectively CmdListener1, CmdListener2, and CmdListener1 for instructions I15, I16, and I17.

Step E27 is followed by a step E28 of identifying the manager representatives that were defined by instantiating the event manager objects identified in preceding step E27.

These manager representatives are respectively I13 and I14 for the manager object arguments CmdListener1 and CmdListener2.

The loop constituted by steps E22 to E28 stops after processing the three instructions calling on the association method.

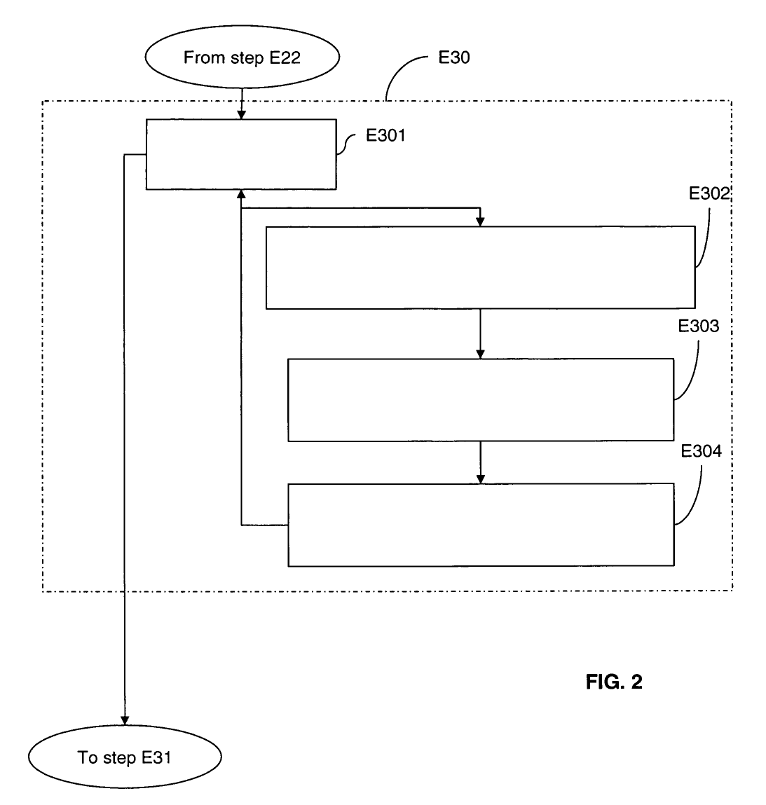

This loops serves to implement a first stage E30 that is described below with reference to FIG. 2.

This first stage E30 is constituted by a loop of steps E301 to E304.

This loop is implemented for each call to the association method setCommandListener I15, I16, I17. It comprises a first step E302 of identifying the screen representatives associated with the call.

In the example described herein, for the calls I15, I16, and I17 respectively, the screen representatives identified in step E302 are respectively I1, I2, and I3.

Step E302 is followed by a step E303 of identifying the event manager representatives associated with this call, i.e. in this example I13 for I15 and I17 and I14 for I16.

Step E303 is followed by a step E304 of associating each of the screen representatives identified in step E302 with each of the manager representatives identified in step E303.

In this example, the following associations are made:
I1 and I13 in the iteration corresponding to I15;
I2 and I14 in the iteration corresponding to I16; and
I3 and I13 in the iteration corresponding to I17.

Table 1 below summarizes the result of the first stage E30.

TABLE 1

| | | | |
|---|---|---|---|
| Association method call | I15 | I16 | I17 |
| Screen representative | I1 | I2 | I3 |
| Manager representative | I13 | I14 | I13 |

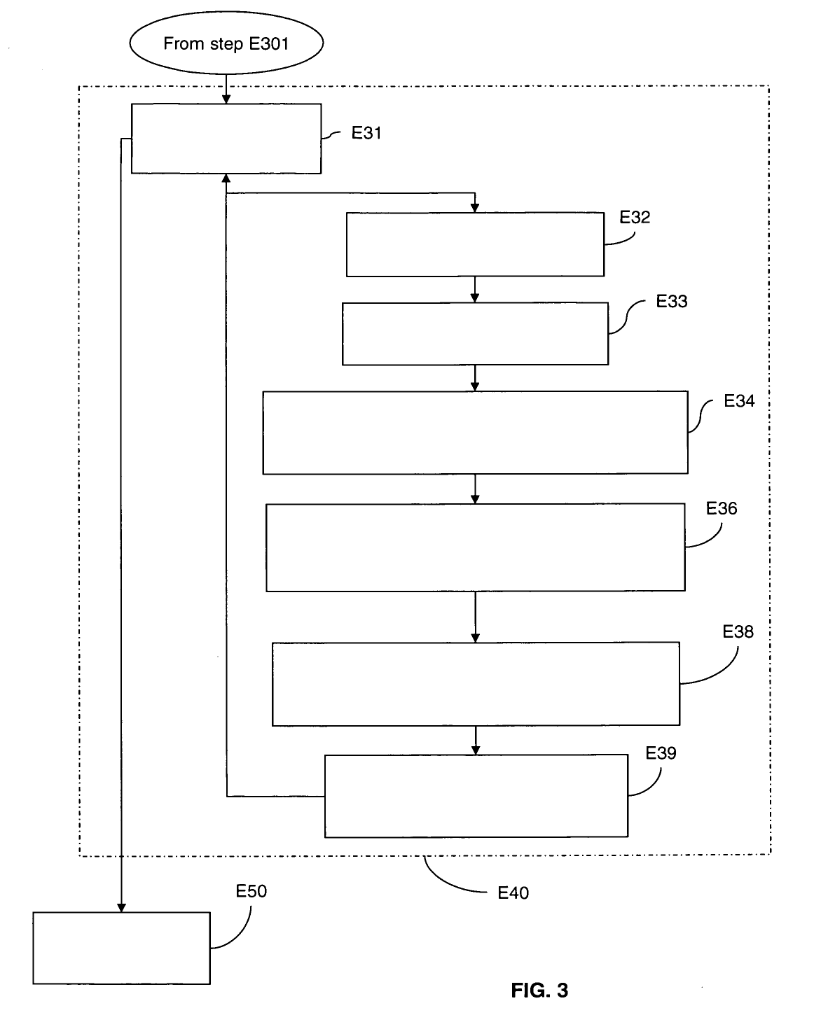

The first stage E30 is followed by a second stage E40 described below with reference to FIG. 3.

In the preferred implementation described herein, this second stage E40 is constituted by a loop E31 to E39 implemented for each callback method CmdListener1.commandAction and CmdListener2.commandAction.

This loop comprises a first step E32 of identifying all of the event manager objects that include this callback method. Thus, in the example described herein, for the callback methods CmdListener1.commandAction and CmdListener2.commandAction, these event manager objects are respectively CmdListener1 and CmdListener2.

Step E32 is followed by a step E33 of identifying the instructions in which these event manager objects are instantiated.

In the example described herein, these instructions are respectively I13 and I14 for the event manager objects CmdListener1 and CmdListener2.

This step E33 is followed by a step E34 of identifying the manager representatives defined for instantiating these event managers.

In this example, the representatives are respectively the instructions I13 and I14.

Step E34 is followed by a step E36 of identifying the instructions calling on the screen change method (setCurrent) that might occur during execution of these callback methods.

In the example described herein, these instructions setCurrent that might occur during execution of the CmdListener1.commandAction (or CmdListener2.commandAction) method are the instructions I18, I21, I24, and I25 (or I28 and I29, as the case may be).

This step E36 is followed by a step E38 of determining the screen objects that can be passed as an argument in each of these calls to the setCurrent screen change method.

In this example:
for the call of instruction I18, this object is screen1;
for the call of line I21, this object is screen3;

for the call of line I24, this object is screen1;
for the call of line I25, this object is screen2;
for the call of line I28, this object is screen3; and

for the call of line I29, this object is screen1.

Step E38 is followed by a step E39 of identifying the screen representatives defined for instantiating this screen object.

As specified several times above, the representatives of screens screen1, screen2, and screen3 are respectively the instructions I1, I2, and I3.

This loop E31 to E39 terminates when each callback method has been processed.

Table 2 below summarizes the result of this second stage E40.

TABLE 2

| | | |
|---|---|---|
| Callback method | | Screen object |
| call | Screen object | representative |

Manager representative: I13

| | | |
|---|---|---|
| I18 | screen1 | I1 |
| I21 | screen3 | I3 |
| I24 | screen1 | I1 |
| I25 | screen2 | I2 |

Manager representative: I14

| | | |
|---|---|---|
| I28 | screen3 | I3 |
| I29 | screen1 | I1 |

The second stage E40 is followed by a step E50 of creating the approximation graph for the behaviors of the man/machine interface of the application.

This graph can be deduced directly from Table 1 and Table 2.

This graph is shown in FIG. 5.

It comprises a certain number of nodes N1, N2, N3 each illustrating a screen representative I1, I2, I3.

This graph also has arcs each connecting an “origin” node to a “destination” node if, and only if, there exists a manager representative I13, I14 such that:
the manager representative was identified during the first stage E30 for the screen representative illustrated by the origin node; and
the screen representative illustrated by the destination node was identified during the second stage E40 for the manager representative.

This graph includes, for example, an arc α having its origin at node N1 illustrating the screen representative I1 and its destination at node N3 illustrating the screen representative I3, because there exists a manager representative I13 identified during the first stage E30 for the screen representative I1 (column 2 in Table 1); and the screen representative I3 illustrated by the destination node N3 was identified during the second stage E40 for the manager representative I13 (row 4 in Table 2).

APPENDIX 1
import javax.microedition.midlet.*;
import javax.microedition.lcdui.*;
public class Test2 extends MIDlet {

| static Form | screen1 = new Form(“Screen 1”),(I1) |
|---|---|
| | screen2 = new Form(“Screen 2”),(I2) |
| | screen3 = new Form(“Help”);(I3) |

static Command exitCmd = new Command(“Exit”, Command.EXIT,
2);(I4)
static Command okCmd = new Command(“OK”, Command.OK, 1);(I5)
static Command helpCmd = new Command(“Help”, Command.OK,
1);(I6)
private String info1Msg = “Press OK to go to Screen 2, or help”;
private String info2Msg = “Select: loop, read help, exit”;
private String info3Msg = “Help. Press OK”;
Display display;
public Test2( ) {

display = Display.getDisplay(this);
screen1.append(new StringItem(“”,info1Msg));
screen2.append(new StringItem(“”,info2Msg));
screen3.append(new StringItem(“”,info3Msg));
screen1.addCommand(okCmd);(I7)
screen2.addCommand(okCmd);(I8)
screen3.addCommand(okCmd);(I9)
screen1.addCommand(helpCmd);(I10)
screen2.addCommand(helpCmd);(I11)
screen2.addCommand(exitCmd);(I12)
CommandListener cmdListener1 = new
CmdListener1( );(I13)
CommandListener cmdListener2 = new
CmdListener2( );(I14)
screen1.setCommandListener(cmdListener1);(I15)
screen2.setCommandListener(cmdListener2);(I16)
screen3.setCommandListener(cmdListener1);(I17)

}
public void startApp( ) { display.setCurrent(screen1);(I18) }
public void pauseApp( ) { }
public void destroyApp(boolean unconditional) { }
class CmdListener1 implements CommandListener {

public void commandAction(Command cmd, Displayable d) {

if (cmd == exitCmd)(I19) { destroyApp(true);
notifyDestroyed( ); }
else if (cmd == helpCmd)(I20) display.setCurrent(screen3);(I21)
else if ((cmd==okCmd)(I22) && (d==screen3)(I23))

display.setCurrent(screen1)(I24);

else display.setCurrent(screen2);(I25)

}

}
class CmdListener2 implements CommandListener {

public void commandAction(Command cmd, Displayable d) {

if (cmd == exitCmd)(I26) { destroyApp(true);
notifyDestroyed( ); }
else if (cmd == helpCmd)(I27) display.setCurrent(screen3)(I28);
else display.setCurrent(screen1)(I29);

}

}
}

1. A method of creating an approximation graph for the behaviors of the man/machine interface of an application, said application being written in an object-oriented language with classes and with typed bytecode executing in an execution environment of a terminal provided with a display device, said application handling screen objects representing the content at a given instant of the display device, each screen object being associated by an association method with an event manager object including a callback method defined for the class of said event manager object and called directly by the execution environment, said method comprises the following steps:
a step of defining at least one screen representative for each application instruction in which a screen object is instanced;
a step of defining at least one manager representative for each application instruction in which an event manager object is instanced;
a first stage of identifying, for each screen representative, the manager representatives that were defined for instantiating an event manager object associated with a screen object for the instantiation of which said screen representative was defined;
a second stage of identifying, for each group of manager representatives that were defined for instantiating event manager objects including the same callback method, the screen representatives that were defined for the screen objects that are put into place during execution of said callback method; and
a step of creating a graph comprising both nodes, each illustrating a screen representative, and arcs, each connecting an “origin” node to a “destination” node if, and only if, there exists a screen representative such that:
this screen representative was identified during said first stage for the screen representative illustrated by said “origin” node; and
the screen representative illustrated by the “destination” node was identified during said second stage for the manager representative.

2. A method according to claim 1, wherein, in order to implement said first stage, a step is performed of determining the instructions of the application in which a call is made to said association method, and the following are determined for each call to said method:
the screen representatives that were defined for instantiating screen objects that can be passed as arguments in said call; and
the manager representatives that were defined for instantiating event manager objects that can be passed as arguments in said call.

3. A method according to claim 1, wherein during said second stage, a prior step is performed of determining for each callback method:
the instructions of the application in which there is instantiated an event manager object that includes said callback method;
the manager representatives that were defined for instantiating these event manager objects;
the calls to the screen change method that might occur during execution of said callback method; and
the screen representatives that were defined for instantiating screen objects that can be passed as arguments in each of the calls to the screen change method.

4. A method according to claim 2, wherein a prior step is performed of determining, for each manager representative, the declared variables in the application that might contain an event manager object for the instantiation of which the manager representative was defined.

5. A method according to claim 2, wherein a prior step is performed of determining, for each screen representative, the declared variables in the application that might contain a screen object for the instantiation of which the screen representative was defined.

6. A computer program including instructions for executing the step of the method of creating a graph according to claim 1, when said program is executed by a computer.

7. A computer-readable storage medium storing a computer program comprising instructions for executing steps of the graph creation method according to claim 1.

8. A computer, comprising a storage medium according to claim 7.

9. A method of evaluating an application, said evaluation being based at least on the analysis of an approximation graph for the behavior of the man/machine interface of said application, wherein said approximation graph is obtained by a method of creating an approximation graph according to claim 1.

10. A method according to claim 3, wherein a prior step is performed of determining, for each screen representative, the declared variables in the application that might contain a screen object for the instantiation of which the screen representative was defined.

11. A method according to claim 4, wherein a prior step is performed of determining, for each screen representative, the declared variables in the application that might contain a screen object for the instantiation of which the screen representative was defined.
